(19) United States
(12) Patent Application Publication
(10) Pub. No.: US 2014/0379363 A1
(43) Pub. Date: Dec. 25, 2014

(54) PATIENT READMISSION RISK ASSESSMENT

(71) Applicant: Passport Health Communications, Inc., Franklin, TN (US)

(72) Inventors: Christopher Forbes Hart, Nashville, TN (US); Lance Clifford Mansfield, Seattle, WA (US)

(73) Assignee: PASSPORT HEALTH COMMUNICATIONS, INC., Franklin, TN (US)

(21) Appl. No.: 14/309,076

(22) Filed: Jun. 19, 2014

Related U.S. Application Data
(60) Provisional application No. 61/836,875, filed on Jun. 19, 2013.

(51) Int. Cl. G06F 19/00

(52) U.S. Cl. CPC G06F 19/3431
USPC 705/2

(57) ABSTRACT

Patient risk assessment if provided. Admissions scenarios that may negatively affect a health care provider's quality metric may be identified, and a patient risk score may be calculated and used to determine a likelihood of readmission of a patient. One or a combination of weighted factors may be utilized in determining quality metric contribution and for calculating the patient risk score. According to the calculated risk score, a case management recommendation may be provided.

### CROSS-REFERENCE TO RELATED APPLICATIONS

The application claims priority to U.S. Provisional Patent Application No. 61/836,875 titled “Patient Readmission Risk Assessment” filed Jun. 19, 2013, the disclosure of which is hereby incorporated by reference in its entirety.

### BACKGROUND

Since the inception of the Affordable Care Act, health care providers, such as hospitals, may be paid incentives and rewards for inpatient care services based on care quality, not just the quantity of the services they provide. Health care providers may be charged with payment penalties based on how they perform on quality metrics by government insurance centers, for example, the Center of Medicare and Medicaid. For example, the Hospital Value-Based Purchasing and Readmissions Reduction Program by the Centers for Medicare and Medicaid Services (CMS) comprises various sets of measures used to score hospitals. For the Value-Based Purchasing payments, the measures include process measures, patient experience/satisfaction measures, and mortality rate measures. For the Readmissions Reduction Program, an excess readmission rate for patients who seek heath care services for certain conditions, such as acute myocardial infarction (AMI), heart failure (HF), pneumonia (PN), chronic obstructive pulmonary disease (COPD), elective hip arthroplasty (THA), total knee arthroplasty (TKA), etc., is calculated. If a heath care provider's readmission rate is above the calculated rate, a payment penalty may be applied.

Many providers may also be a part of certain organizations, for example the Accountable Care Organization (ACO) where providers come together voluntarily to provide coordinated, high quality care to their patients. An organization, such as the ACO, may provide savings incentives by offering bonuses when providers keep costs down and meet specific quality benchmarks, focus on prevention, and carefully manage patients with chronic diseases. In other words, providers may be paid more for keeping their patients healthy and out of the hospital.

Accordingly, being able to identify which patients contribute to a quality metric, identify admissions scenarios that may negatively affect a health care provider's quality score, and being able to determine a likelihood of readmission of a patient early in the revenue cycle may be advantageous for health care providers. By knowing which patients or cases may contribute to a quality metric and also which patients or cases may negatively affect a health care provider's quality score or cause them to not meet specific quality benchmarks, the health care provider may be enabled to intervene with case management and not only increase their quality score for Medicare reimbursement and/or incentives, but may also decrease commercial denials for clinically unusual circumstances. It is with respect to these and other considerations that the present invention has been made.

### SUMMARY

Various embodiments of a patient risk assessment system identify admissions scenarios that may negatively affect a health care provider's quality metric and calculate a patient risk score used to determine a likelihood of readmission of a patient. Contribution to the health care provider's quality metric may be determined and a patient risk score may be calculated for each patient registration. One or a combination of factors may be utilized in determining quality metric contribution and for calculating the patient risk score, the one or more factors including but not limited to: a patient's age, sex, race, marital status, weight, height, health vital signs/readings (e.g., blood pressure, pulse rate, etc.), history of diseases or illness (e.g., diabetes, heart disease, etc.), habits (e.g., smoking, alcohol/drug use), fitness/exercise regimen, number of previous hospital admissions, illnesses associated with previous admissions, distance between the patient's primary residential address and the address of the health care provider, income, order and insurance data, etc.

Patients whose admission negatively affect a health care provider's quality score and patients likely to be readmitted may be determined in a pre-service clearance workflow. By identifying patients/cases whose admissions negatively affect a health care provider's quality score and patients likely to be readmitted in a pre-service clearance workflow, a health care provider may be able to take preventative measures to manage such cases. For example, priority may be given to certain patients, a work queue may be determined that orders cases in such a way as to help minimize a negative impact on the health care provider's quality metric by identified cases, certain patients may be scheduled for outpatient treatments rather than inpatient treatments, as well as other preventative measures may be taken.

By focusing case management on the riskiest cases, resources may be focused where they are needed most, may enable health care providers to take advantage of rewards allocated to providers who provide high quality care, and may help eliminate or reduce various fines imposed by the various government insurance services based on readmission rates.

### BRIEF DESCRIPTION OF DRAWINGS

Further features, aspects, and advantages of the invention represented by the embodiments described present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a simplified block diagram of a high-level system architecture in which embodiments of the present invention may be practiced;

FIG. 2 is an example risk assessment system user interface;

FIG. 3 is a flow chart of a method for providing patient risk assessment according to an embodiment; and

FIG. 4 is a simplified block diagram of a computing device with which embodiments of the present invention may be practiced.

### DETAILED DESCRIPTION

A patient risk assessment system and method is described herein and illustrated in the accompanying figures. The patient risk assessment system identifies admissions scenarios that may negatively affect a health care provider's quality metric, sometimes referred to as a quality score, and calculates a patient risk score used to determine a likelihood of readmission of a patient.

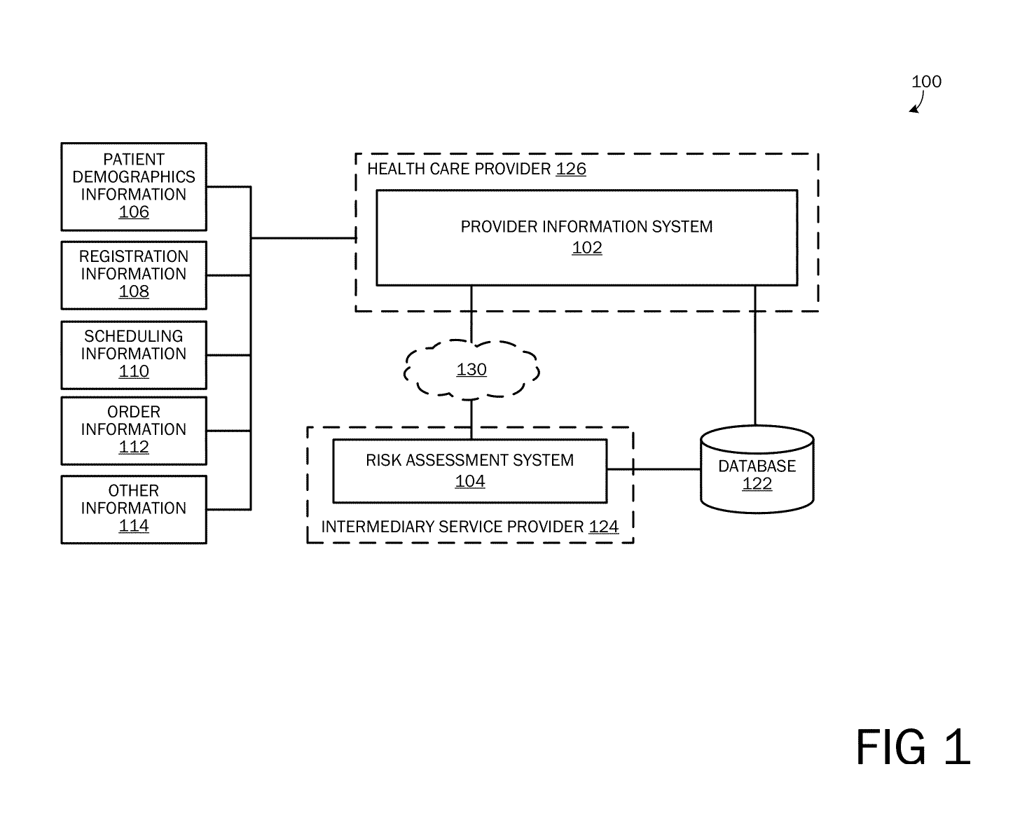

FIG. 1 illustrates an embodiment of a high-level system architecture 100 which may provide a suitable operating environment for the patient risk assessment system 104. The system 100 may comprise a provider information system 102, which may be an integrated information system operable to receive and manage various aspects of a health care provider operation. For example, the provider information system 102 may be utilized to receive and manage one or more of patient demographics information 106, registration information 108, scheduling information 110, order information 112, and other information 114 such as charging and billing information, insurance information, back office information, medical records information, accounts receivables information, etc.

According to an embodiment, the patient risk assessment system 104 may be maintained by the health care provider 126. The risk assessment system 104 may be integrated with the provider information system 102, or may be in communication with the provider information system 102 over a computer network 130, such as the Internet.

According to another embodiment, the patient risk assessment system 104 may be maintained and operated by an intermediary service provider 124 that acts as an interface between health care providers 126 and payers to normalize communication solutions, data requirements, and transaction formats.

Patient demographics information 106, registration information 108, scheduling information 110, order information 112, and other information 114 may be locally or remotely stored in one or more databases 122. According to embodiments, patient risk analysis data and patient risk scores calculated by the patient risk assessment system 104 may be stored in the one or more databases 122.

According to embodiments and as briefly described above, the patient risk assessment system 104 may be operable to identify patients and cases that may adversely impact a health care provider's quality metric. The quality metric may be an evaluation of the health care provider 126 based on specific measures and quality benchmarks and may be utilized to determine whether the health care provider 126 is eligible for incentives, bonuses, and the like, or whether the health care provider 126 is at risk for being charged with payment penalties. For example, measure and quality benchmarks may include various process measures, patient experience/satisfaction measures, mortality rate measures, readmissions rate measures, etc.

According to an embodiment, the patient risk assessment system 104 may be operable to identify patients and cases that may adversely impact the health care provider's quality metric early in the patient workflow, such as during the pre-service clearance workflow according to the information received and available to the patient risk assessment system 104. For example, the patient risk assessment system 104 may process information (e.g., patient demographics information 106, registration information 108, scheduling information 110, order information 112, and other information 114) received at the time of patient registration for identifying patients and cases that contribute to the provider's quality metric.

According to embodiments, the patient risk assessment system 104 may be further operable to process information received at the time of patient registration and/or during the patient's treatment for inputting factors into an algorithm for calculating a patient risk score utilized to predict a patient's likelihood of being readmitted and to determine other quality measures. The type of information that may be processed may include one or more of patient demographics information 106, registration information 108, scheduling information 110, order information 112, and other information 114. If the patient has a patient record with the health care provider 126, historical data from the patient's record may be utilized.

The factors for determining a patient's likelihood of readmission may comprise the patient's age, sex, race, marital status, income information, employment status, insurance information (e.g., whether the patient receives Medicare or Medicaid benefits, is self-paid, etc., distance between the patient's primary residence and the health care provider 126, a number of times a patient has visited the emergency room, total number of visits to the health care provider 126, a number of missed visits, where an order is placed, injury/illness type, length of stay, drug, alcohol, and/or tobacco use, etc.

Clinical information such as a diagnostics or a procedure ordered for the patient based on the nature of the visit may also be used for predicting a patient's readmission risk. A procedure may translate into a diagnosis-related group code (DRG code) or a medical severity code. As known by those skilled in the art, a DRG code is a grouping code assigned based on a system of classification to identify “products” that a health care provider provides. For example, if the patient's reason for the visit is “nose bleed”, then it may have a lower level severity as compared to a patient who has been admitted for chronic or acute chest pain with high level severity.

According to an embodiment, order information 112 may comprise a code, such as a Current Procedure Terminology (CPT) code. As known by those skilled in the art, a CPT code is a medical code set maintained by the American Medical Association through the CPT Editorial Panel. The CPT code set describes medical, surgical, and diagnostic services, and is designed to communicate uniform information about medical services and procedures among physicians, coders, patients, accreditation organizations, and payers for administrative, financial, and analytical purposes. The CPT code may be compared with the list of CPT codes that may have been identified as procedures with high risk of readmission.

The algorithm may also comprise a comorbidity index factor, which may be utilized to determine what other chronic illnesses a patient has at the time of check in. For example, the patient may be diabetic, may have heart disease, COPD, etc. If the patient is seeking health care services from the health care provider 126 for a condition which may have a lower level severity code, the patient's risk score may be just be higher due to the comorbidity index factor.

Quality metric contribution data and the calculated patient risk score may be used for account prioritization. For example, if a patient has a high risk score, which may mean that the patient is considered likely for readmission and could impact the overall hospital score negatively, the patient may be flagged such that case management staff may place the patient in a priority queue. By involving case management staff early in the process, which may include nurses or other personnel, attention can be focused on providing appropriate care by following the right procedures at the right location. For example, if a patient with a high calculated risk score and thus considered likely for readmission (which would negatively affect the health care provider's quality metric) is seeking treatment for a condition which would be treated in an outpatient setting, the risk assessment system 104 may be operable to provide a notification or an alert to the health care provider staff indicating that the patient should be treated in an outpatient setting. Additional attention may also be focused on clearly communicating discharge instructions to patients with high risk scores to help reduce the likelihood of readmission and to improve service.

The readmission risk score may be made up of a number of permutations of weighted factors. In addition, for any given factor, a variety of information may be used for determining how to weight a given factor. Development of factors and reevaluation of weightings to be applied to various factors that may be used in generating a readmission risk score may include a building process and refinement process where additional factors are added and current factors are reevaluated from time to time based on studies and research regarding the demographic and medical profiles of patients who are admitted and readmitted to health care provider for diagnosis and treatment.

According to an embodiment, risk assessment system 104 may be implemented as a web based model where the data derived from the system 104 may be used for a variety of different tasks. For example, calculated risk assessment data and readmission risk score may be reported to analytics teams across various health care providers 126. As can be appreciated, by health care providers 126 working in a more coordinated way and communicating closely with each other through enhanced sharing of health care information, a better health care experience may be created for patients, and their medical needs may be addressed more efficiently and effectively. Data may also be used internally to compare the health care provider's 126 performance to itself as a benchmark, or may be utilized externally to compare the health care provider's 126 performance to its peers in a network, in a service area, regionally, or nationally. Accordingly, the health care providers 126 may be able to maintain and aim to improve the quality of care.

According to another embodiment, data derived from risk assessment system 104 may be shared and used by various insurance companies (i.e., payers) associated with a health care provider 126. Value may be added for the payer by allowing them to stratify their patient population. For example, if a high readmission risk score is derived as output for a patient, it may indicate to the payer that the patient is a customer with heavy usage, which may then lead to an increase in insurance premiums for the patient.

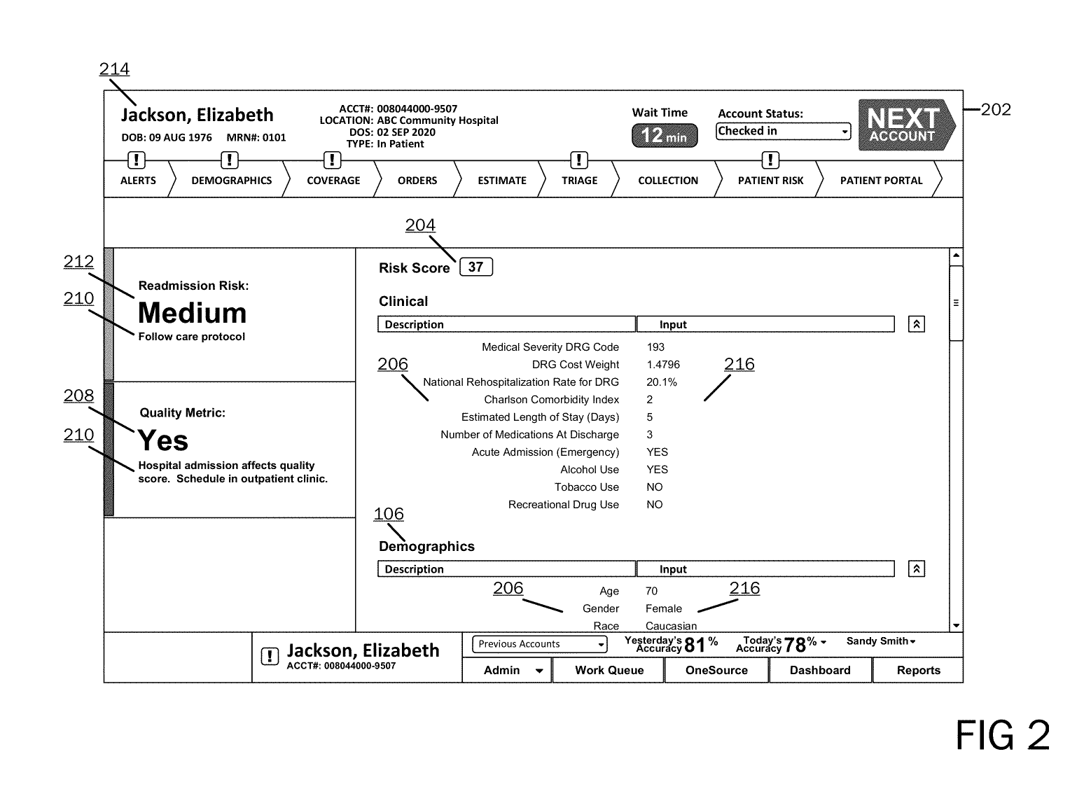

According to embodiments and as illustrated in FIG. 2, a risk assessment system user interface 202 may be provided. The risk assessment system user interface 202 may be utilized for inputting one or more factors 206 for determining a patient's 214 likelihood of readmission. Alternatively, the one or more factors 206 may be automatically populated into the risk assessment system 104 through the provider information system 102 or via other connected systems.

The risk assessment system user interface 202 may also be utilized for providing information to a user, such as an administrative user, a registrar, a scheduler, case management staff, etc. As illustrated, an indication 208 of whether admission of the patient 214 will affect the health care provider's 126 quality metric may be provided. The indication 208 may be in a form of a “yes” or “no” answer. Additionally, a case management recommendation 210 may be provided.

A display of the one or more factors 206 utilized to determine a patient's 214 readmission risk and the actual input data 216 for each of the one or more factors 206 may be provided in the risk assessment system user interface 202. A patient's 214 readmission risk score 204 may also be displayed. According to an embodiment, the higher the readmission risk score 204, the higher probability that the patient 214 will be readmitted within a predetermined time period and thus negatively affect the health care provider's 126 quality metric. Calculation of the readmission risk score 204 may be made in real time as the data is being entered which may provide useful information as to which factor impacts the score.

The readmission risk score 204 may be rated as low risk, medium risk, or high risk. The rating 212, which may be a predictive indication of whether a patient is likely to be readmitted or if the patient is not likely to be readmitted may be displayed in the risk assessment system user interface 202. According to an embodiment, an option to calculate and display the score may be made available for selection. A recommendation 210 for case management may also be displayed, which may include a general or specific queue to which the patient 214 should be assigned.

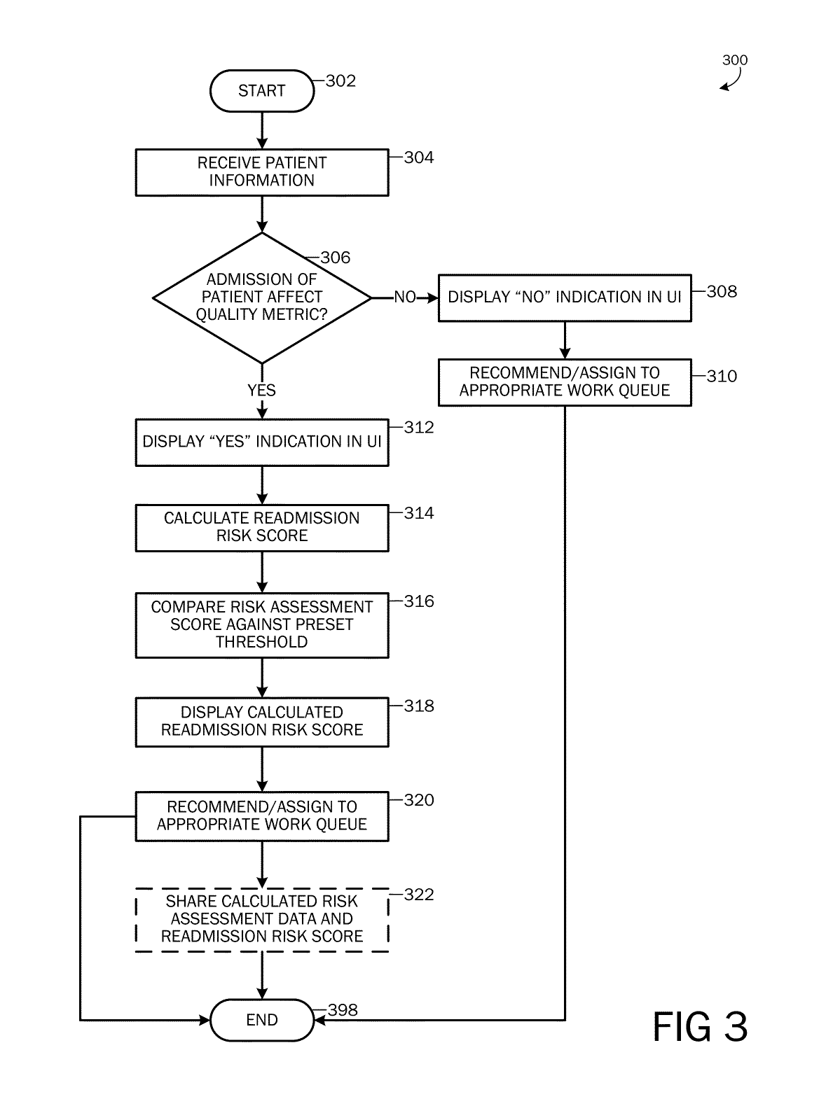

Embodiments of the present invention, for example, are described above with reference to block diagrams and/or operational illustrations of methods, systems, and computer program products according to embodiments of the invention. For example, FIG. 3 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

With reference to FIG. 3, a method 300 to provide patient risk assessment is shown. The method 300 may start at OPERATION 302, and may proceed to OPERATION 304 where a patient 214 seeks health care services from a health care provider 126, and the patient's 214 registration information 108 may be entered into the health care provider's provider information system 102. For example, an administrative staff member, scheduling staff member, registration personnel, or the patient 214 may enter the registration information 108. It may be noted that if the patient 214 is a first time patient, the registration information 108 may be entered and a new electronic medical record may be created; whereas, if the patient has been previously seen by the health care provider 126, legacy data from the facility's systems for the patient 214 may be pulled, and an order to perform a required procedure may be created.

The method 300 may proceed to DECISION OPERATION 306, where a determination may be made as to whether the admission of the patient 214 will affect the health care provider's quality metric. According to an embodiment, the determination may be based on the condition for which the patient 214 is seeking health care services. For example if the patient 214 is seeking health care services for certain conditions such as acute myocardial infarction (AMI), heart failure (HF), pneumonia (PN), chronic obstructive pulmonary disease (COPD), elective hip arthroplasty (THA), total knee arthroplasty (TKA), etc., a determination may be made that admission of the patient 214 will affect the health care provider's quality metric.

According to another embodiment, the determination may be based on the patient's 214 order. The order may comprise a diagnosis and the procedure. At this point, various other factors may be considered, such as to which facility the patient 214 is admitted and whether the patient is to be treated as an inpatient or an outpatient, whether it is an ambulatory environment or a clinical environment, whether the patient was admitted into the Emergency Room (ER) or was a walk-in or had an appointment, etc. Various factors may be used for predicting whether the patient is likely going to be readmitted or if the patient is not likely to be readmitted. Embodiments may provide for a determination to be made from the patient's order and the insurance information as to whether the patient 214 will contribute to the quality metric or the readmission rate calculation. The above determination may take into account a strategy or a formula with a set of weightings that government insurance services may use to assess an entity and adjust the readmission rate to ensure penalties and fines imposed on the providers are fair.

If a determination is made that admission of the patient 214 will not affect the health care provider's quality metric, the method 300 may proceed to OPERATION 308, where a “no” indication 208 may be displayed in the risk assessment system user interface 202.

The method 300 may proceed from OPERATION 308 to OPERATION 310, where a case management recommendation 210 may be provided. For example, the case management recommendation 210 may indicate to schedule the patient 214 for inpatient services.

If a determination is made at DECISION OPERATION 306 that admission of the patient may affect the health care provider's quality metric, the method 300 may proceed to OPERATION 312, where a “yes” indication 208 may be displayed in the risk assessment system user interface 202.

The method 300 may proceed from OPERATION 312 to OPERATION 314, where the readmission risk score 204 may be calculated. That readmission risk score 204 may determine if the patient is more or less likely to be readmitted. As briefly described above, various factors, including but not limited to, patient age, sex, other demographic information, marital status, weight, height, health vital signs/readings (e.g., blood pressure, pulse rate, etc.), history of diseases or illness (e.g., diabetes, heart disease, etc.), habits (e.g., smoking, alcohol/drug use), fitness/exercise regimen, number of previous hospital admissions, illnesses associated with previous admissions, order and insurance data, and the like may be considered for predicting a likelihood of readmission and other quality measures.

For example, consider a patient 214 having the following patient risk assessment factor input data 216: Age—22 years; Sex—male; Marital Status—married; Weight—165 pounds; height—5 feet, 10 inches; low to normal blood pressure and pulse rate; no know diseases; non-smoker and low alcohol use; regular exercise participant; and only previous hospital admission for broken arm caused by fall in tennis match. For such a patient 214, each factor 206 would likely receive a relatively low score in terms of likelihood of readmission, and owing to the fact that the previous admission was due to an accident that is not associated with a disease, the overall readmission risk score 204 likely would be low. For example, if the readmission risk score 204 is calculated on a scale of 1-10, where 1 is the lowest risk of readmission, then such a patient 214 may receive a score of 1 or 2. On the other hand, if the same patient 214 presented with exactly the same patient risk assessment factor input data 216, but the previous admission was owing to a discovered heart condition, then that single factor 206 may cause the readmission risk score 204 to rise to a much higher level, for example, a score of 8 on the example 1-10 scale.

For another example, consider a patient 214 having the following patient risk assessment factor input data 216: Age—55 years; Sex—male; Marital Status—divorced; Weight—240 pounds; height—5 feet, 9 inches; high blood pressure and pulse rate; history of heart disease and borderline diabetes; smoker; little to no exercise participant; and two previous hospital admissions (one for chest pain analysis and one for influenza complications). For such a patient 214, each factor 206 would likely receive a relatively high readmission risk score 204 in terms of likelihood of readmission, and owing to the fact that the previous admissions were considered related to or exacerbated by the patient's health history, the overall readmission risk score 204 likely would be high. For example, if the readmission risk score 204 is calculated on a scale of 1-10, where 1 is the lowest risk of readmission, then such a patient 214 may receive a score of 8-10.

As should be appreciated, the foregoing examples are for purposes of illustration only and are not exhaustive of the vast numbers of different factors 206 that could be used for calculating a readmission risk score 204. Moreover, any given score could be made up of a great number of permutations of weighted factors 206. In addition, for any given factor 206, a wide variety of information may be used for determining how to weight a given factor. For example, while age may be considered a strong assessment factor 206, certain other factors 206, for example, preexisting illness associated with a previous hospital admission, may be weighted significantly more. Other factors 206, for example, marital status, may bear some statistical relationship with readmission frequency, but such factors 206 may be weighted significantly less than other factors 206, such as history of smoking, for example. Thus, as should be appreciated and as stated above, development of factors 206 and reevaluation of weightings to be applied to various factors 206 that may be used in generating a readmission risk score 204 may include a building process and refinement process where additional factors 206 are added and current factors 206 are reevaluated from time to time based on studies and research regarding the demographic and medical profiles of patients 214 who are admitted and readmitted to hospitals for diagnosis and treatment.

The method 300 may proceed from OPERATION 314 to OPERATION 316, where the calculated readmission risk score 204 may be compared with preset thresholds, and at OPERATION 318, the calculated readmission risk score 204 may be displayed in the risk assessment user interface 202.

The method 300 may proceed to OPERATION 320, where a case management recommendation 210 may be provided, and an appropriate work queue may be assigned to help reduce the likelihood of readmission. For example, the case management recommendation 210 may indicate to schedule the patient 214 for outpatient services to avoid a negative effect of on the health care provider's quality metric.

The method 300 may end at OPERATION 398, or may proceed to OPERATION 322, where data derived by the risk assessment system 104 may be shared, for example, reported to analytics teams across various health care providers 126, used internally to compare the health care provider's 126 performance to itself as a benchmark, may be utilized externally to compare the health care provider's 126 performance to its peers in a network, in a service area, regionally, or nationally, or may be shared with payers. The method ends at OPERATION 398.

Embodiments of the invention may be implemented via local and remote computing and data storage systems. Such memory storage and processing units may be implemented in a computing device, such as computing device 400. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

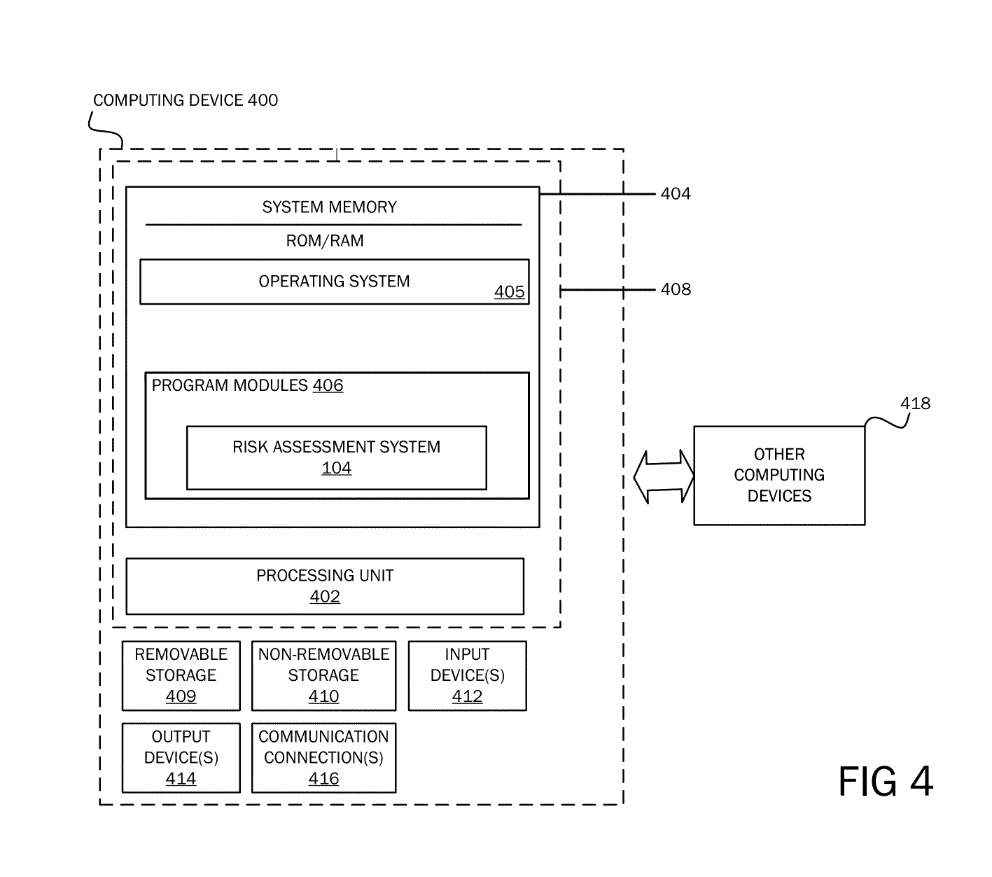

FIG. 4 illustrates one embodiment of a computing device suitable to implement embodiments of the invention. The computing device 400 may include at least one processing unit 402 and a system memory 404. The system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include the risk assessment system 104, having sufficient computer-executable instructions, which when executed, performs functionalities as described herein. Operating system 405, for example, may be suitable for controlling the operation of computing device 400. Furthermore, embodiments of the invention may be practiced in conjunction with a graphics library, other operating systems, or any other application program and is not limited to any particular application or system. This basic configuration is illustrated by those components within a dashed line 408. Computing device 400 may also include one or more input device(s) 412 (keyboard, mouse, pen, touch input device, etc.) and one or more output device(s) 414 (e.g., display, speakers, a printer, etc.).

The computing device 400 may also include additional data storage devices (removable and/or non-removable) such as, for example, magnetic disks, optical disks, or tape. Such additional storage is illustrated by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

Program modules, such as the risk assessment system 104, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system.

Although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data and/or computer-executable instructions readable by a computing device. Computer-readable storage medium do not include communications media.

Embodiments of the present invention may be utilized in various distributed computing environments where tasks are performed by remote processing devices that are linked through a communications network.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing patient risk assessment, the method comprising:
receiving patient information for a patient seeking health care services with a health care provider;
analyzing the received patient information;
making a determination that admission of the patient for health care services affects a quality metric for the health care provider;
calculating a readmission risk score for the patient; and
displaying the calculated readmission risk score in a user interface.

2. The method of claim 1, wherein receiving patient information for a patient seeking health care services comprises receiving one or a combination of:
demographics information;
registration information;
scheduling information;
order information;
insurance information;
medical records information; or
accounts receivables information.

3. The method of claim 1, wherein making a determination that admission of the patient for health care services affects a quality metric for the health care provider comprises determining the patient is seeking health care services for one of:
acute myocardial infarction;
heart failure;
pneumonia;
chronic obstructive pulmonary disease;
elective hip arthroplasty; or
total knee arthroplasty.

4. The method of claim 1, wherein calculating a readmission risk score for the patient comprises receiving input data for one or more weighted factors, the one or more weighted factors comprising one or a combination of:
age;
sex;
race;
marital status;
income information;
employment status;
insurance information;
distance between the patient's primary residence and the health care provider;
a number of times the patient has visited an emergency room within a predetermined time period;
a total number of visits the patient has visited the health care provider;
a number of missed visits;
where an order is placed;
injury/illness type;
length of stay;
drug use;
alcohol use;
tobacco use; or
exercise regimen.

5. The method of claim 1, further comprising determining and displaying a rating in the user interface, the rating providing a predictive indication of whether the patient is likely to be readmitted or if the patient is not likely to be readmitted.

6. The method of claim 1, further comprising determining and displaying a recommendation for case management for the patient based on the calculated readmission risk score.

7. The method of claim 1, further comprising sharing derived risk assessment data and the calculated readmission risk score with other health care providers and with payers.

8. A system for providing patient risk assessment, the system comprising:
one or more processors; and
a memory coupled to the one or more processors, the one or more processors operable to:
receive patient information for a patient seeking health care services with a health care provider;
analyze the received patient information;
make a determination that admission of the patient for health care services affects a quality metric for the health care provider;
calculate a readmission risk score for the patient; and
display the calculated readmission risk score in a user interface.

9. The system of claim 8, wherein the system is web-based.

10. The system of claim 8, wherein in making a determination that admission of the patient for health care services affects a quality metric for the health care provider, the one or more processors are operable to determine admission of the patient for health care services affects a quality metric for the health care provider according to the Hospital Readmissions Reduction Program by the Centers for Medicare and Medicaid Services.

11. The system of claim 8, wherein in calculating a readmission risk score for the patient, the one or more processors are operable to receive input data for one or more weighted factors, the one or more weighted factors comprising one or a combination of:
age;
sex;
race;
marital status;
income information;
employment status;
insurance information;
distance between the patient's primary residence and the health care provider;
a number of times the patient has visited an emergency room within a predetermined time period;
a total number of visits the patient has visited the health care provider;
a number of missed visits;
where an order is placed;
injury/illness type;
length of stay;
drug use;
alcohol use;
tobacco use; or
exercise regimen.

12. The system of claim 8, wherein the one or more processors are further operable to determine and display a rating in the user interface, the rating providing a predictive indication of whether the patient is likely to be readmitted or if the patient is not likely to be readmitted.

13. The system of claim 8, wherein the one or more processors are further operable to determine and display a recommendation for case management for the patient based on the calculated readmission risk score.

14. The system of claim 8, wherein the one or more processors are further operable to share derived risk assessment data and the calculated readmission risk score with other health care providers and with payers.

15. A computer readable medium containing computer executable instructions which when executed by a computer perform a method of providing patient risk assessment, the method comprising:
receiving patient information for a patient seeking health care services with a health care provider;
analyzing the received patient information;
making a determination that admission of the patient for health care services affects a quality metric for the health care provider;
calculating a readmission risk score for the patient; and
displaying the calculated readmission risk score in a user interface; and
displaying a recommendation for case management for the patient based on the calculated readmission risk score.

16. The computer readable medium of claim 15, wherein receiving patient information for a patient seeking health care services comprises receiving one or a combination of:
demographics information;
registration information;
scheduling information;
order information;
insurance information;
medical records information; or
accounts receivables information.

17. The computer readable medium of claim 15, wherein making a determination that admission of the patient for health care services affects a quality metric for the health care provider comprises determining admission of the patient for health care services affects a quality metric for the health care provider according to the Hospital Readmissions Reduction Program by the Centers for Medicare and Medicaid Services.

18. The computer readable medium of claim 17, wherein determining admission of the patient for health care services affects a quality metric for the health care provider according to the Hospital Readmissions Reduction Program by the Centers for Medicare and Medicaid Services comprises determining the patient is seeking health care services for one of:
acute myocardial infarction;
heart failure;
pneumonia;
chronic obstructive pulmonary disease;
elective hip arthroplasty; or
total knee arthroplasty.

19. The computer readable medium of claim 15, wherein calculating a readmission risk score for the patient comprises receiving input data for one or more weighted factors, the one or more weighted factors comprising one or a combination of:
age;
sex;
race;
marital status;
income information;
employment status;
insurance information;
distance between the patient's primary residence and the health care provider;
a number of times the patient has visited an emergency room within a predetermined time period;
a total number of visits the patient has visited the health care provider;
a number of missed visits;
where an order is placed;
injury/illness type;
length of stay;
drug use;
alcohol use;
tobacco use; or
exercise regimen.

20. The computer readable medium of claim 15, further comprising determining and displaying a rating in the user interface, the rating providing a predictive indication of whether the patient is likely to be readmitted or if the patient is not likely to be readmitted.
